(19) United States
(12) Patent Application Publication
(10) Pub. No.: US 2008/0209737 A1
(43) Pub. Date: Sep. 4, 2008

(54) Safe cutter

(76) Inventor: David M. Storms, Spring Hill, TN (US)

Correspondence Address: DAVID M. STORMS, 3005 STEWART CAMPBELL POINTE, SPRING HILL, TN, 37174, US

(21) Appl. No.: 11/712,773

(22) Filed: Mar. 1, 2007

(51) Int. Cl. B26B 3/00

(52) U.S. Cl. 30/114

(57) ABSTRACT

The Safe Cutter, hereafter, “Cutter” is a device that cuts hot dogs into horizontal and vertical slices. The Cutter is designed to cut the hot dog into specified increments reducing the shape, size and diameter of the hot dog. This methodology of cutting a hot dog will prevent individuals, especially children, from choking on a hot dog based on its size and shape. The Cutter is composed of one horizontal blade and several vertical blades that are attached. In addition, the Cutter has a sleeve that holds the hot dog to be cut. Finally, the Cutter has a handle and a sleeve to cover the blades when not in use. Once the hot dog is cooked, one hot dog is placed in the Cutter's sleeve then with a downward motion the Cutter cuts the hot dog into a horizontal slice and vertical slices. There is no device on the market today that is specifically designed to cut a hot dog into horizontal and vertical slices. This is not just another invention, this is a device that will save lives by reducing, if not eliminating individuals and especially children from choking on a hot dog based on its shape and size.

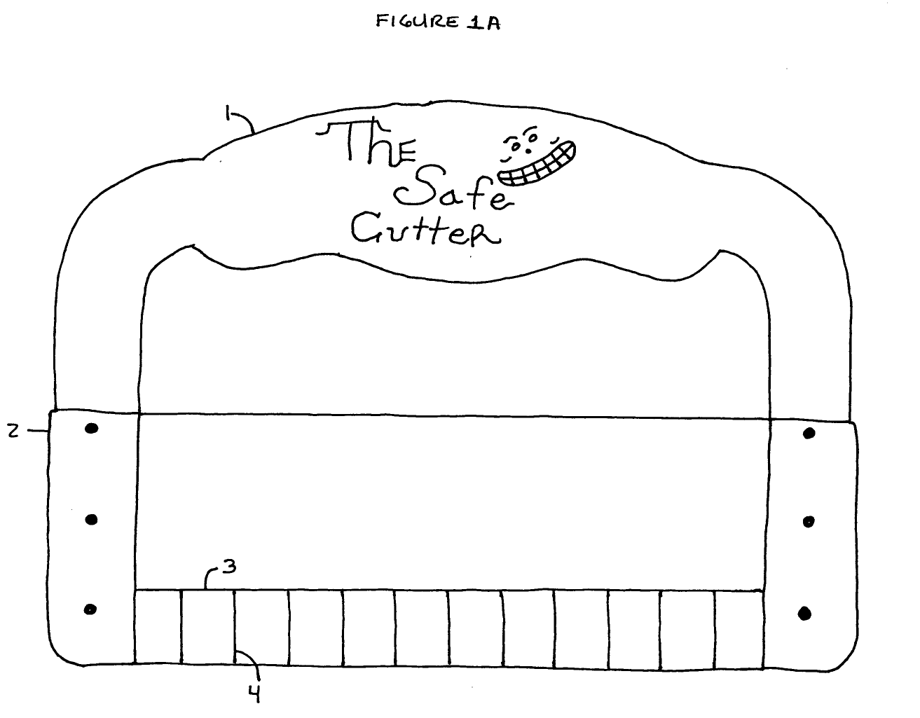

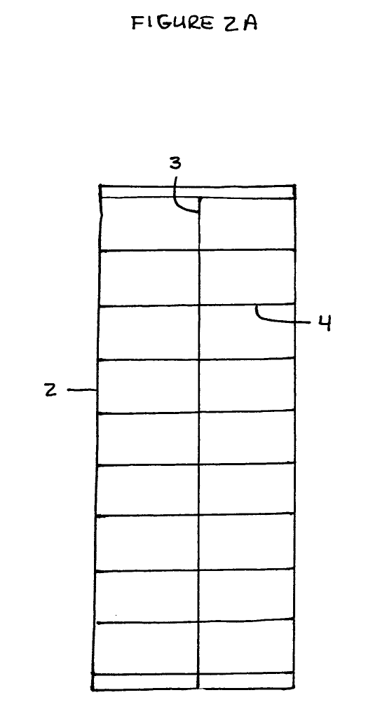

The Safe Cutter, hereafter, “Cutter” is designed to cut a hot dog at specified increments to ensure that an individual, especially a child, will not swallow too big of a piece and block their airway which could lead to death. The majority of childhood choking occurs with food. Because the hot dog is round, the cutter will cut horizontal and vertical; therefore, greatly reducing the risk of choking. The Cutter will allow the hot dog to be cut into small pieces that will easily break apart when eating. The Cutter can be made out of stainless steel, plastic, titanium or any other metal alloy, but is not limited to these components as far as its make up. The Cutter will consist of a horizontal blade and vertical blades. The Cutter's sleeve and handle may also be made out of plastic or any metal alloy but is not limited to said components. The sleeve will act as a chamber to hold and position the hot dog for cutting. Once the hot dog is placed in the sleeve the user will exert downward pressure to cut the hot dog into horizontal and vertical pieces. FIG. 1A descriptions are 1, the handle, 2, the sleeve which holds the hot dog prior to cutting and houses the blades when not in use. The horizontal blade is 3 and the vertical blades are 4. FIG. 2A descriptions are 2, the sleeve, 3, the horizontal blade and 4, the vertical blades. FIG. 2A is a bottom view of the blades housed by the sleeve. This specification contains no new matter.

### CROSS REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND OF THE INVENTION

The Safe Cutter is a hot dog cutter. The Safe Cutter, hereafter, “Cutter” will cut each hot dog whether it is beef, pork, turkey or any other type of hot dog frank into horizontal and vertical slices. Each vertical slice of the hot dog will be at fixed increments to ensure that the distance between each vertical cut is the same. Once cut, the hot dog will break up easily due to the fact that it is segmented by the “Cutter.” There is no technology on the market today that is specifically used to cut a hot dog frank. Each year children suffocate from eating hot dogs because they are swallowing large chunks of a hot dog frank and because it is round and slick, once lodged, it is nearly impossible to save a child. The “Cutter” is beneficial to anyone such as stroke victims, people who have difficulty swallowing because it segments the hot dog into smaller pieces and makes it more palatable. In conclusion, the Safe Cutter will bring piece of mind to all who use it.

### BRIEF SUMMARY OF THE INVENTION

The Safe Cutter as previously mentioned is a hot dog cutter. The Safe Cutter, hereafter “Cutter” will cut the hot dog into horizontal and vertical slices. Cutting the hot dog into these slices will prevent anyone from choking on a hot dog because it breaks the hot dog up into smaller segments altering the size and shape of each piece of the hot dog. Slicing the hot dog in this manner will prevent children and physically challenged people such as stroke victims from choking on a hot dog based on the shape and diameter of the hot dog. The advantage of having the “Cutter” is simple, it will save lives. The consumer will now have the option to purchase the “Cutter” which will consistently cut any hot dog into safe segments making the hot dog not only safe to eat but enjoyable and will give parents especially, peace of mind. The “Cutter” solves the dangers of choking and eliminates this existing problem because there is nothing on the market that is specifically designed to cut a hot dog into safe segments for the consumer.

### DETAILED DESCRIPTION OF THE INVENTION

The Safe Cutter is a hot dog cutter that cuts the hot dog into horizontal and vertical slices altering the shape and size of each piece of the hot dog which will prevent choking based on the shape and diameter of the hot dog. The Safe Cutter, hereafter, “Cutter” will have a sleeve to hold the hot dog as depicted in FIG. 1A #2. As depicted in FIG. 1A, the horizontal blade is #3 and the vertical blades are #4. The handle is indicated by #1. The horizontal and vertical blades of the Cutter are attached and the blade edges are straight.

FIG. 2A is a bottom view of the blades housed by the sleeve. On FIG. 2A, #2 is the sleeve, #3 is the horizontal blade and #4 is the vertical blades. The user will place the hot dog into the sleeve of the cutter after it has been cooked, take the cutter and push directly down on the hot dog while holding the handle and cut the hot dog into vertical and horizontal segments. The cutter stands alone because there is no cutter on the market today specifically for the use of cutting a hot dog. There are many kitchen items that cut various vegetables, lettuce, etcetera, but nothing designed to cut the all American hot dog. The improvement is offering the cutter to the consumer so they can safely cut a hot dog for consumption and stop children and others from choking based on the shape and diameter of a hot dog that is not cut. The blades can be made out of stainless steel, plastic or any other metal that is safe for consumer use. The handle can be made out of plastic, rubber or any other material that ensures a firm grip. The cutter is not limited by its drawing, shape or design, but is to be patented based on its application and methodology.

1. What I claim as my invention is the “Safe Cutter” that cuts a hot dog into horizontal and vertical segments which will prevent children primarily and others from choking on a hot dog based on the diameter and shape of the hot dog.

2. What I claim as my invention is the “Safe Cutter,” hereafter, “Cutter” that has a horizontal blade and vertical blades that have straight edges and fit flush with the sleeve that has a flat bottom.

3. What I claim as my invention is the cutter that has a handle and sleeve to cover the blades when not in use.

4. What I claim as my invention is the cutter that has a sleeve where the hot dog will be placed before it is cut into horizontal and vertical segments as according to claim 2.

5. What I claim as my invention is the cutter which can be made out of stainless steel, plastic or any metal alloy but is not limited to these components as far as its makeup and design as according to claim 3.
